(19) United States
(12) Patent Application Publication
(10) Pub. No.: US 2018/0010433 A1
(43) Pub. Date: Jan. 11, 2018

(54) FLUID FLOW ENGINEERING SIMULATOR OF MULTI-PHASE, MULTI-FLUID IN INTEGRATED WELLBORE-RESERVOIR SYSTEMS

(71) Applicant: Halliburton Energy Services, Inc., Houston, TX (US)

(72) Inventors: Hongfei Wu, Katy, TX (US); Srinath Madasu, Houston, TX (US); Avi Lin, Houston, TX (US)

(21) Appl. No.: 15/537,936

(22) PCT Filed: Feb. 5, 2015
(86) PCT No.: PCT/US2015/014577

§ 371 Date: Jun. 20, 2017

(51) Int. Cl. E21B 43/16; E21B 41/00; G06F 17/50

(52) U.S. Cl. CPC E21B 43/16; G06F 17/5018; E21B 41/0092; G06F 2217/16

(57) ABSTRACT

Computer-implemented methods for higher-order simulation, design and implementation of multi-phase, multi-fluid flows are disclosed. In one embodiment, a computer-implemented method is provided for a higher-order simulation, design and implementation of a strategy for injecting a plurality of stimulation fluids into a subterranean formation. In another embodiment, a computer-implemented method for higher-order simulation and enhancement of the flow of production fluids from a subterranean formation is disclosed. In a third embodiment, a computer-implemented higher-order simulation of the behavior of a plurality of fluids at an intersection of at least two geometrically discrete regions is disclosed.

### TECHNICAL FIELD

The present disclosure relates generally to multi-phase, multi-fluid flow and, more particularly, to computer-implemented methods for simulating fluid flow in subterranean formations, e.g., during the completion, stimulation, fracturing or enhancement of a well or the production of fluids from the well.

### BACKGROUND

Multi-phase, multi-fluid flow in a porous media is a problem of great practical importance in a variety of natural physical processes, as well as a host of industrial applications, such as in petroleum engineering and medical engineering, among many others. Fluid displacement occurs when temporal sequences of different fluids interact with each other, and is characterized by the movement of the interface or front between the fluids. The present disclosure describes and analyzes a new practical and efficient fluid displacement simulator with sound physics, mathematical formulations, and numerical discretization, which is applicable to simulate the miscible fluid displacement in large scale integrated wellbore-reservoir (IWR) systems.

The present disclosure attempts to address two major challenges with properly simulating the multi-phase, multi-fluid flow phenomena in petroleum engineering. One of the major challenges involves enhanced oil recovery and enabling a practical and an economical multi-fluid displacement model that can capture the two most prominent characteristics, namely, the length of the mixing zone and the front characteristics of the displaced fluid by accounting for mainly convection, diffusion, viscosity difference, density difference, and surface tension among other parameters such as difference in temperature conduction coefficients and the like. Existing models for the fluid displacement in reservoir stimulation treat the phenomenon like piston displacement. This simplified method is relatively easy to implement and this commonly used, yet it is based on the assumption that fluids in placement processes have some additional physical properties such that there are no diffusion processes or interfaces between the fluids, which in many instances, is not physically correct. The Buckley-Leverett type approach is one of the improved models for immiscible fluid displacement, yet its basic governing equation cannot be rigorously justified because the curvature of the fluid-fluid interface is expressed as the square root of the permeability of the porous media, which is oftentimes not the case. A reduced one-dimension scalar convective-diffusive model for this case is proposed in International Patent Application No. PCT/US2014/015882 filed by Wu et al., where an effective diffusion coefficient and a retarding convective factor are introduced to better and more physically correctly consider the effects on the miscible fluid displacement from the convection and advection, viscosity difference, and density difference.

The second major challenge is accurately predicting the multi-fluid flow dynamics in an IWR system with high numerical stability features. The accurate prediction of fluid displacement is essential to locating the acid fronts of the hydrocarbons during matrix production enhancement. This task involves the coupling of high wellbore flows, low flows in the reservoir, and the fluid front tracking; all are tightly coupled in a computational implicit approach. The modeling of these fluid displacement processes requires the Navier-Stokes (NS) equations to describe the fluid dynamics in the wellbore, Darcy equations to properly model the porous media flow in the reservoir, as well as a fluid displacement model to capture the fluid front dynamics and the mixing zone size. These mathematically partial differential equations are different in each sub-region of the flow domain of interest and thus must be connected through suitable connection conditions that describe the fluid flow across the permeable interface, where the fluid flows between the wellbore and the reservoir are coupled. Mathematical difficulty arises from Darcy equations containing the pressure's second-order derivatives and velocity's first-order derivative—while it is the other way around in the NS system—and a lack of coupling equations for the scalar, which is used in a convection-diffusion model to characterize the fluid displacement process. Therefore, the fluid transport in such coupled systems has received detailed attention, both from the mathematical and numerical point of view and it was recently extended to open-hole completion systems. The extension includes coupling mechanisms of hybrid NS and Darcy's systems, where the mass and pressure continuity at the junction points, and that velocity or pressure at junctions, is modeled by Darcy's law. However, it appears that the fluid displacement dynamics in any completion system have not been reported yet.

A second order upwind renormalization (SOUR) scheme to simulate a multi-fluid displacement process in a vertical wellbore open-hole completion system is described in detail below. The overall methodology includes coupling mechanisms to describe scalar, velocity, and pressure variables at the junction points, numerical simulation approaches to solve different systems of the specific governing partial differential equations in each domain, and geometrical modeling of open-hole completion systems. The numerical algorithm made the simulation of the fluid displacement process in any completion system stable, accurate, fast, feasible, efficient, and simple to use.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a schematic diagram of miscible fluid displacement in an open-hole vertical well completion system for bullheading;

FIG. 2 illustrates a computational grid arrangement for the variables in miscible fluid displacement;

FIG. 3 illustrates a comparison of method of manufactured solution (MMS) for test functions ofu=xt, p=xt, and c=xt in the wellbore and u=rt, p=rt, and c=rt in the reservoir at time t=1.49;

FIG. 4 illustrates a comparison of MMS for test functions of u=xt, p=t cos(πx), and c=xt in the wellbore and u=rt, p=t cos(πr), and c=rt in the reservoir at time t=1.49;

FIG. 5 illustrates the compressibility effects on the fluid density in the reservoir at t=10.59.;

FIG. 6 illustrates the concentration distributions along the wellbore and the reservoir of shown case at t=2000.0; and

FIG. 7 illustrates the pressure distributions along the wellbore and the reservoir of shown case at t=2000.0;

FIG. 8 illustrates the velocity distributions along the wellbore and the reservoir of shown case at t=2000.0;

FIG. 9 illustrates the viscosity distributions along the wellbore and the reservoir of shown case at t=2000.0;

FIG. 10 illustrates (a) the velocity, (b) concentration, and (c) pressure distributions along the wellbore and the reservoir at t=2.49 sec and a Reynolds number of 10,000.

### DETAILED DESCRIPTION

Illustrative embodiments of the present disclosure are described in detail herein. In the interest of clarity, not all features of an actual implementation are described in this specification. It will of course be appreciated that in the development of any such actual embodiment, numerous implementation specific decisions must be made to achieve developers' specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following examples be read to limit, or define, the scope of the disclosure.

The present disclosure presents a new numerical methodology and computational solver for multi-fluids and/or multiphase flows to describe integrated wellbore-reservoir multiphase (IWRM) petrophysics. The wellbore's high-velocity flow continuously interacts with the reservoir's relative low-velocity (Darcy-like) flow, especially around the perforation regions. Fast flows are adequately described by the unsteady Navier-Stokes (NS) equations, while slow flows are often modeled using the unsteady Darcy equations. The fluids' miscible displacement model is given by the unsteady convection-diffusion process for fluid interface tracking. The computational methods for solving the governing partial differential equations (PDEs) must be stable, consistent and computationally efficient, with the objective of obtaining relevant solutions using adequate and simple to implement numerical schemes. The present disclosure sets forth the governing equations of the IWR system, new fluid junction condition formulations, and a new spatial second-order stable finite difference formulation that enables solving implicitly the model's equations.

Extending these new formulations to multi-physics fluids systems naturally enables the coupling of the wellbore's NS equations with the reservoir's porous media Darcy equations through the physical connection conditions applied at the flow's junction zones. The currently used connection conditions models are of a shared scalar value type, implemented for the pressure, interface's concentration, density, and viscosity. These relationships ensure the flow's mass continuity and momentum conservation for the coupled wellbore and reservoir flows. For a one-dimensional (1D) case, the flow loss occurs at an infinitesimally small area, resulting in a mathematical singularity, which is relieved in the current methodology by using a double nodes formulation. The staggered scheme couples the pressure and velocity variables, while the velocity, concentration, density, and viscosity variables are collocated. The numerical stability of the convection terms is accomplished by using the novel second-order upwind renormalization (SOUR) scheme, which uses the original governing equation to generate second-order accurate terms in the Taylor series expansion. The standard second-order upwind (SOU) scheme cannot be used near the boundaries; thus, the novel SOUR scheme was enhanced to be applicable at all discrete points in the flow domain.

The simulation is validated by using the method of manufactured solution (MMS). The results demonstrate that for the first time, the formulation and numerical scheme set forth herein are robust, stable, and accurate for all ranges of flow velocities commonly observed in IWR models.

### Mathematical Model

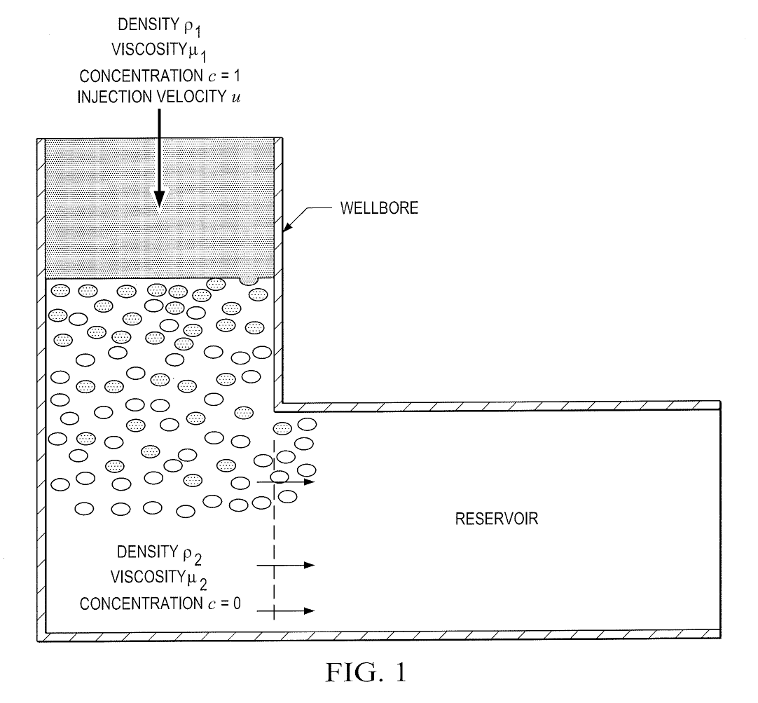

Consider fluid flow through a coupled isothermal open-hole well, as schematically depicted in FIG. 1. The open-hole well is composed of a vertical wellbore and a reservoir component. The wellbore has a diameter of D meters and a length of L_{w} meters. The reservoir has a radius of rₑ and height of H meters, respectively, for the pay zone. The reservoir and wellbore are connected through an open-hole completion. Initially, the reservoir is assumed to have a uniform horizontal distribution of permeability, K(m²), and porosity, φ. To ease the computational burden on two-dimensional (2D) or three-dimensional (3D) flow in the reservoir formation, the reservoir is modeled as a uniformly distributed multilayered zone so that the flow is axisymmetric and no cross-flow occurs between different reservoir layers resulting from negligible vertical permeability. Therefore, the open-hole completion system is modeled as a 1D flow network, in which each layer of the reservoir is connected with the wellbore at the junction points with no intra connections between the layers.

The system is initially filled with the resident Fluid 2, characterized by a density of ρ₂(kg/m³) and viscosity of μ₂(pa·s). Fluid 1, with a viscosity μ₁(pa·s) and density ρ₁(kg/m³), is injected through the wellhead, as in bullheading scenarios, at a velocity of u(t)(m/s) to displace the resident Fluid 2. To depict the fluid displacement, assume that an artificial marker is also initially filled with the system having a concentration c=0, and the same marker but with c=1 is also simultaneously injected into the system through the wellhead along with the Fluid 1 injection. The marker, as a variable c, indicates the local volume concentration of the injected fluid. The two fluids are miscible, subject to a constant diffusion coefficient, Dₘ(m²/s). The compressibility effects are taken into consideration in the classical the thermodynamic fashion as it is explicitly given later by eqs. (11) and (12) with two constant compressibility values a₁(Pa⁻¹), and a₂(Pa⁻¹) for fluid 1 and fluid 2 in the reservoir, respectively.

The flow in the wellbore is described by NS equations, while it is governed by Darcy's law equations in a multilayered reservoir. The concentration field c is governed by a modified convection-diffusion equation for both the wellbore and reservoir (Wu et al. 2013), and the variation of density and viscosity with the injected fluid concentration are specified. All of these equations, along with connection conditions and boundary and initial conditions, are specified hereafter for the fluid flow and the concentration evolution in three geometric domains: wellbore, reservoir, and fluid junction zones within an open-hole completion system.

### The Wellbore Domain

The fluid and marker dynamics in the wellbore are governed by the following cross-sectionally averaged mass and momentum conservation and convection-diffusion equations, respectively, so that for the 1D Cartesian coordinate system, they are as follows:

$$\begin{matrix}\frac{\partial ρ}{\partial t} + \frac{\partial }{\partial x} ( ρ u ) = 0 & ( 1 ) \\ \frac{\partial ( ρ u )}{\partial t} + \frac{\partial ( ρ {u}^{2} )}{\partial x} + \frac{\partial p}{\partial x} + {f}_{f} \frac{ρ {u}^{2}}{π D} = \frac{\partial }{\partial x} ( μ \frac{\partial u}{\partial x} ) + ρ g cos θ & ( 2 ) \\ \frac{\partial c}{\partial t} + \frac{\partial }{\partial x} ( λ uc ) = \frac{\partial }{\partial x} ( {D}_{e} \frac{\partial c}{\partial x} ) & ( 3 )\end{matrix}$$

where Eq. 1 is the fluid mass continuity and Eq. 2 is the momentum conservation equation, and where the density ρ and viscosity μ are modeled by means of linear functions of concentration c as follows:

ρ=(ρ₁−ρ₂)c+ρ₂ (4)

μ=(μ₁−μ₂)c+μ₂ (5)

The friction force f_{f} in the momentum Eq. 2 is modeled as

$${f}_{f} = \{ \begin{matrix}\frac{64}{Re} & Re \leq 2300 \\ 0.079 {Re}^{- 0.25} & Re > 2300\end{matrix}$$

where the Reynolds number is defined as

$$Re = \frac{ρ UD}{μ}$$

and U is chosen as the injected fluid average velocity at the wellhead. The retarding convective factor λ and effective diffusive coefficient Dₑ in the modified convection-diffusion Eq. 3 are modeled as the following:

$$λ = 1 - ( {λ}_{d} + {λ}_{μ} \frac{{μ}_{2} - {μ}_{1}}{{μ}_{2} + {μ}_{1}} + {λ}_{ρ} \frac{{ρ}_{1} - {ρ}_{2}}{{ρ}_{2} + {ρ}_{1}} ) \sqrt{\frac{{f}_{f}}{2}}$$

$${D}_{e} = {D}_{m} + ( {D}_{d} + {D}_{μ} \frac{{μ}_{2} - {μ}_{1}}{{μ}_{2} + {μ}_{1}} + {D}_{ρ} \frac{{ρ}_{1} - {ρ}_{2}}{{ρ}_{2} + {ρ}_{1}} ) UD$$

The retarding convective factor λ depends on four contributions—pure convection, the retarding dispersion λ_{d}, the viscosity difference λ_{μ}, and the density difference λₚ. Similarly, the effective diffusive coefficient Dₑ also depends on four contributors, namely the molecular diffusion (Dₘ), the dispersion (D_{d}), the viscosity difference (D_{μ}), and the density difference (D_{ρ}). These seven parameters must be evaluated from appropriate experiments or by means of average operations over the 2D or 3D computational simulations on the same simulation scenarios; see, for example, Wu et al. (2013).

### The Reservoir Domain

The governing equations for the fluids and the marker in the reservoir are similar as for the wellbore but are formulated in a radial coordinate system for the flow in a porous medium, and the momentum equation is replaced by Darcy's equation for the porous media.

$$\begin{matrix}\frac{\partial ( φ ρ )}{\partial t} + \frac{\partial ( r ρ u )}{\partial r} = 0 & ( 6 ) \\ u = - \frac{K}{μ} \frac{\partial p}{\partial r} & ( 7 ) \\ \frac{\partial ( φ c )}{\partial t} + \frac{1}{r} \frac{\partial }{\partial r} ( r λ uc ) = \frac{1}{r} \frac{\partial }{\partial r} ( r ( {D}_{e} + {D}_{d ρ} ) φ \frac{\partial c}{\partial r} ) & ( 8 )\end{matrix}$$

The fluid density ρ and viscosityμ, as well as both the retarding convective factor λ and effective diffusive coefficient Dₑ, are modeled similarly to their formulation in the wellbore domain. The additional D_{dp} term is the kinematic dispersion in a porous reservoir, and its current model is D_{dp}=a_{L}|u|, where a_{L} is the longitudinal dispersivity.

The density and viscosity mixture of two fluids are modelled as the same as those in Eq. (4), and Eq. (5), for convenience, they are also repeated here for the reservoir domain.

ρ=(ρ₁−ρ₂)c+ρ₂ (9)

μ=(μ₁−μ₂)c+μ₂ (10)

In addition, two fluids in the reservoir satisfies the equation of state

dρ₁=a₁ρ₁dp (11)

dρ₂=a₂ρ₂dp (12)

### The Connection Conditions

The reservoir formation is decomposed into uniform N layers, with the layer's height as h(=H/N). To properly connect the flow and the marker in the wellbore and reservoir, connection equations are required at all N connection points. These connection equations include the mass conservation, the marker conservation, pressure continuity, density continuity, viscosity continuity, and Darcy's law to model the velocity uᵣ at all connection points, except the last one. Specifically, at any connection point i(i≠N), the equations are as follows:

$$\begin{matrix}{ρ}_{in} {u}_{w , in} - {ρ}_{out} {u}_{w , out} = \frac{2 h}{{R}_{w}} {ρ}_{r} {u}_{r} & ( 13 ) \\ {c}_{in} {u}_{w , in} - {c}_{out} {u}_{w , out} = \frac{2 h}{{R}_{w}} {c}_{r} {u}_{r} & ( 14 ) \\ {p}_{w} = {p}_{r} & ( 15 ) \\ {μ}_{w} = {μ}_{r} & ( 16 ) \\ {ρ}_{w} = {ρ}_{r} & ( 17 ) \\ {u}_{r} = - \frac{K}{μ} \frac{\partial p}{\partial r} & ( 18 )\end{matrix}$$

At the last connection point, because all of the remaining fluid and markers leave the domain, the connection equations include mass conservation, the marker conservation, density continuity, viscosity continuity, and Darcy's law to model the pressure as the following:

$$\begin{matrix}{u}_{w} = \frac{2 h}{{R}_{w}} {u}_{r} & ( 19 ) \\ {c}_{w} = {c}_{r} & ( 20 ) \\ {μ}_{w} = {μ}_{r} & ( 21 ) \\ {ρ}_{w} = {ρ}_{r} & ( 22 ) \\ \frac{\partial p}{\partial r} = - \frac{μ}{ρ} {u}_{r} & ( 23 )\end{matrix}$$

where any variable with subscripts r and w represent the variable at reservoir and wellbore, respectively, and any variable (i.e., the velocity and concentration of the marker) with subscripts in and out represent the variable flows into and out of the intersection, respectively.

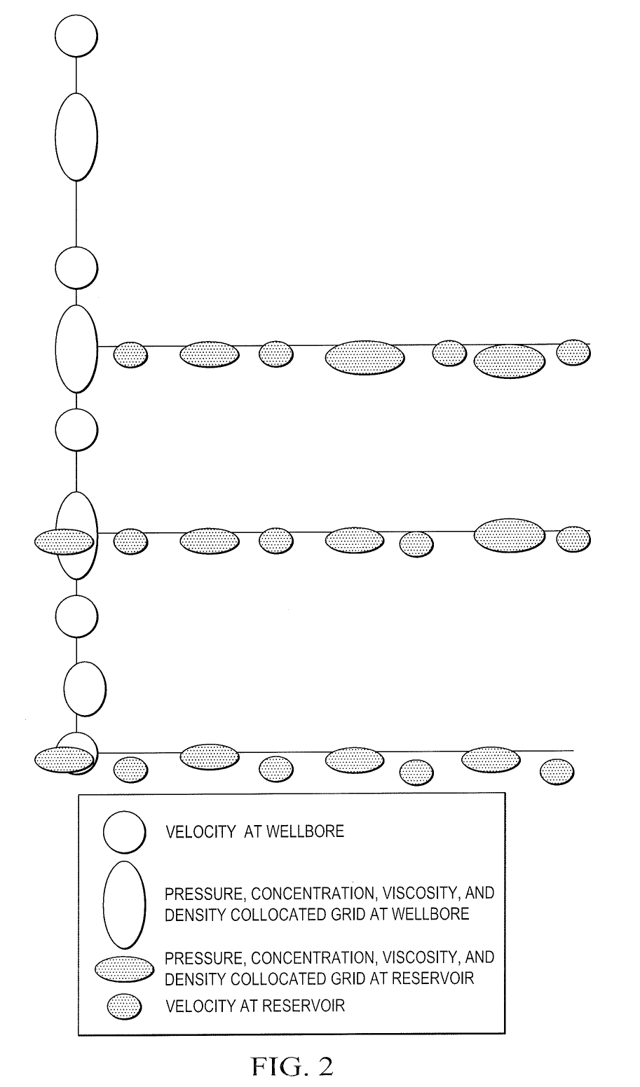

Equation 15 matches the pressure in the wellbore and reservoir at the junctions, except at the last junction point. At that point, the mass and all scalars, including the concentration, density, and viscosity flow, are matched, yet pressure is obtained from Darcy's law using Eq. 23. The pressure grid in the wellbore is connected to the reservoir pressure grid at the junctions, as can been observed in FIG. 2, while the velocity grid at the last junction is connected to the pressure grid, ensuring continuity of pressure and velocity, respectively, in the respective junctions. The flow loss at the junction zones in the 1D simulation, for an infinitesimal area, results in a mathematical singularity, which is not a real physical singularity. It was found that using double nodes at the junction zones relieves the mathematical singularity; yet, the concentration, density, and viscosity are collocated with velocity. This is a novel method for implicitly integrating the wellbore and reservoir with the mass, momentum, concentration flux, density, and viscosity conserved. Therefore, this tightly coupled methodology results in robust simulations of the miscible fluid displacement in hybrid wellbore-reservoir systems.

### The Boundary and Initial Conditions

Appropriate boundary conditions and initial conditions are required to close the system of equations. The following conditions are used:

$$\begin{matrix}u {\vert}_{x = 0} = {u}_{inlet} & ( 24 ) \\ c {\vert}_{x = 0} = 1.0 & ( 25 ) \\ ρ {\vert}_{x = 0} = {ρ}_{1} & ( 26 ) \\ μ {\vert}_{x = 0} = {μ}_{1} & ( 27 ) \\ \frac{\partial ( φ c )}{\partial t} + \frac{1}{r} \frac{\partial ( {λ}_{r} ruc )}{\partial r} {\vert}_{r = {r}_{e}} = 0 & ( 28 ) \\ p {\vert}_{r = {r}_{e}} = {p}_{e} & ( 29 ) \\ u {{\vert}_{x = L} = 0 , c \vert}_{x = L} = 0 & ( 30 )\end{matrix}$$

along with initial conditions of u|ₜ₌₀=0, c|ₜ₌₀=0, ρ|ₜ₌₀=ρ₂, and μ|ₜ₌₀=μ₂.

### The Numerical Algorithm and Results

Numerical Algorithm.

The coupled NS/Darcy equation and fluid displacement convection-diffusion equation system (Eqs. 1 through 12) are numerically marched in time using a first-order implicit method and are solved in space using either a spatially SOUR scheme or first-order upwind scheme for the convective terms and a second-order central scheme for second spatial derivatives. The five variables are arranged as shown in FIG. 2, with the velocity, concentration, density, and viscosity collocated, while the pressure is staggered at the respective discretization nodes. The connection equations (Eqs. 13 through 23) are implemented at the connection points to close the system implicitly.

SOUR Scheme.

The main goal of this scheme is to generate a highly accurate expression for the odd-order derivative terms in the equations, while prevailing the overall diagonal dominance of the discrete equation and maintaining its well-performed, fast, and stable methodology. The SOU scheme is second-order accurate but cannot be used near the boundaries because of its wide stencil. Hence, the SOU scheme must be modified or reverted back to a first-order scheme for application near the boundary nodes. The main advantage of the SOUR scheme is using a unified higher-order scheme throughout the domain without switching or modifying the scheme near the boundaries to be higher-order accurate, such as the standard SOU scheme. The SOUR scheme does this by using the underlying governing equation to express the higher-order derivatives. The SOUR scheme is demonstrated by using the simplified convection-diffusion equation:

$$\frac{\partial C}{\partial t} + \frac{\partial ( uC )}{\partial x} - D \frac{{\partial }^{2} C}{\partial {x}^{2}} = f$$

Discretizing the equation using first-order upwind gives

$$\frac{{C}_{i}^{n + 1} - {C}_{i}^{n}}{Δ t} + \frac{{( uC )}_{i} - {( uC )}_{i - 1}}{Δ x} - D \frac{{C}_{i - 1} 2 {C}_{i} + {C}_{i + 1}}{Δ {x}^{2}} = {f}_{i}$$

To make it second-order accurate, higher-order terms are included:

$$\frac{{C}_{i}^{n + 1} - {C}_{i}^{n}}{Δ t} + \frac{{( uC )}_{i} - {( uC )}_{i - 1}}{Δ x} + \frac{1}{2.} Δ {x ( uC )}_{xxi} - D \frac{{C}_{i - 1} 2 {C}_{i} + {C}_{i + 1}}{Δ {x}^{2}} = {f}_{i}$$

Using the governing equation for (uC)ₓₓᵢ gives

(uC)ₓₓᵢ=fᵢₓ+DCₓₓₓᵢ−Cₓᵢₜ

Substituting in the discretized equation:

$$\frac{{C}_{i}^{n + 1} - {C}_{i}^{n}}{Δ t} + \frac{{( uC )}_{i} - {( uC )}_{i - 1}}{Δ x} + \frac{1}{2.} Δ x ( {f}_{ix} + D {C}_{xxxi} - {C}_{xit} ) - D \frac{{C}_{i - 1} 2 {C}_{i} + {C}_{i + 1}}{Δ {x}^{2}} = {f}_{i}$$

$${C}_{xxxi} = \frac{1}{Δ {x}^{3}} \{ ( {C}_{i + 2} - 3 {C}_{i + 1} + 3 {C}_{i} - {C}_{i - 1} ) - \frac{5 Δ x}{8} {C}_{xxxxi} or \\ Where {C}_{xxxi} = \frac{1}{Δ {x}^{3}} \{ ( {C}_{i + 1} - 3 {C}_{i} + 3 {C}_{i - 1} - {C}_{i - 2} ) + \frac{5 Δ x}{8} {C}_{xxxxi} \\ {C}_{ixt} = - \frac{1}{Δ x} \{ \frac{{C}_{i}^{n + 1} - {C}_{i}^{n}}{Δ t} - \frac{{C}_{i - 1}^{n + 1} - {C}_{i - 1}^{n}}{Δ t} \}$$

As can be observed, the SOUR scheme uses the underlying governing equation to formulate a SOU scheme. This approach can be extended to other equations for stability, accuracy, and computational speed. This formulation can be used for very a high Reynolds number.

Validation.

MMS is a technique used for the current code validation. MMS uses a prescribed function of the solution of the variable to derive an expression for the source term from the governing equation. This source term is added to the linear system to solve for the numerical solution, which can then be compared to the prescribed solution for accuracy and fixing bugs in the code. MMS is a very powerful method for very large scientific codes to validate and verify purposes. This is the first step before experimental or field validation of the actual physics of the problem.

### Example 1

### Linear Test Function

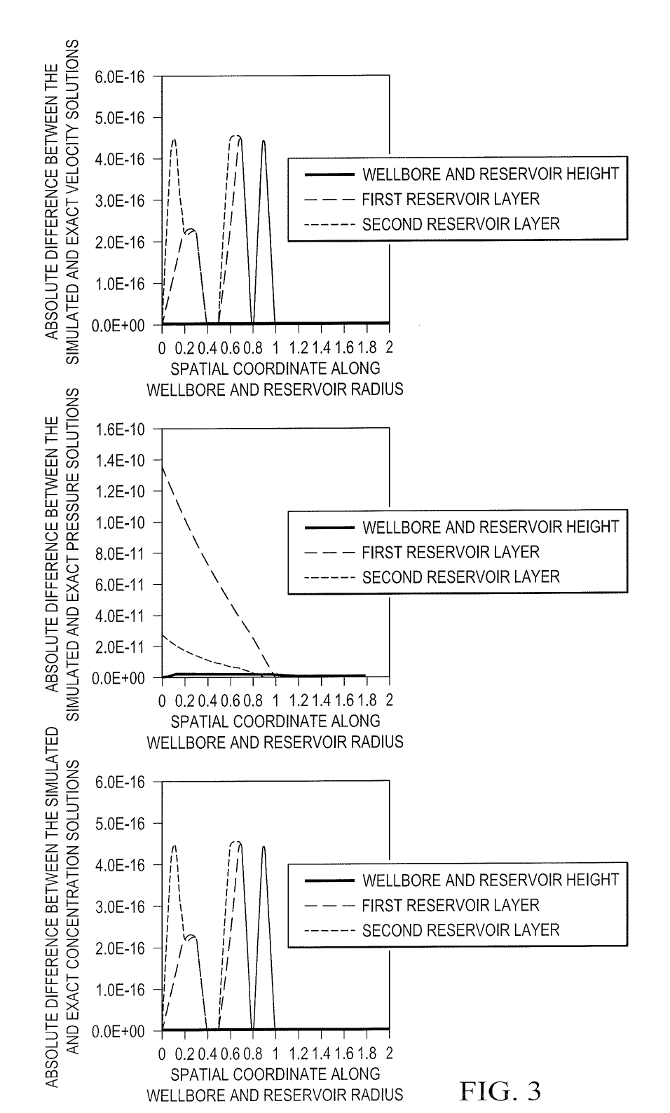

The following test functions were used in the wellbore: u=xt, p=xt, and c=xt, and u=rt, p=rt, and c=rt was the test functions used in the reservoir. Also, only for the MMS, the following values were used: μ₁=2.0×10⁻³(pa·s), ρ₁=2.0×10³(kg/m³), and μ₂=1.0×10⁻(pa·s), ρ₂=1.0×10³(kg/m³), as well as λ=1, Dₑ=D₀=10⁻⁶(m²/s). The computational domain was defined by the wellbore length L_{w}=1.0(m). The wellbore diameter was defined by D_{w}=0.1(m), the reservoir radius by rₑ=1.0(m), the height by H=1.0(m), the permeability by K=1.0×10⁻¹⁰ m², and porosity 0.2. The two junctions were located at x=1.4 and x=1.7. The Reynolds number was 1.0×10⁵. FIG. 3 depicts the results for a grid size of 0.1 m for both the wellbore and reservoir, and a time step of 0.01 seconds. The result shows that the code resolves precisely the linear behavior, even for a larger grid size, with an absolute error of 1.0×10⁻¹⁶.

### Example 2

### Oscillatory Test Function

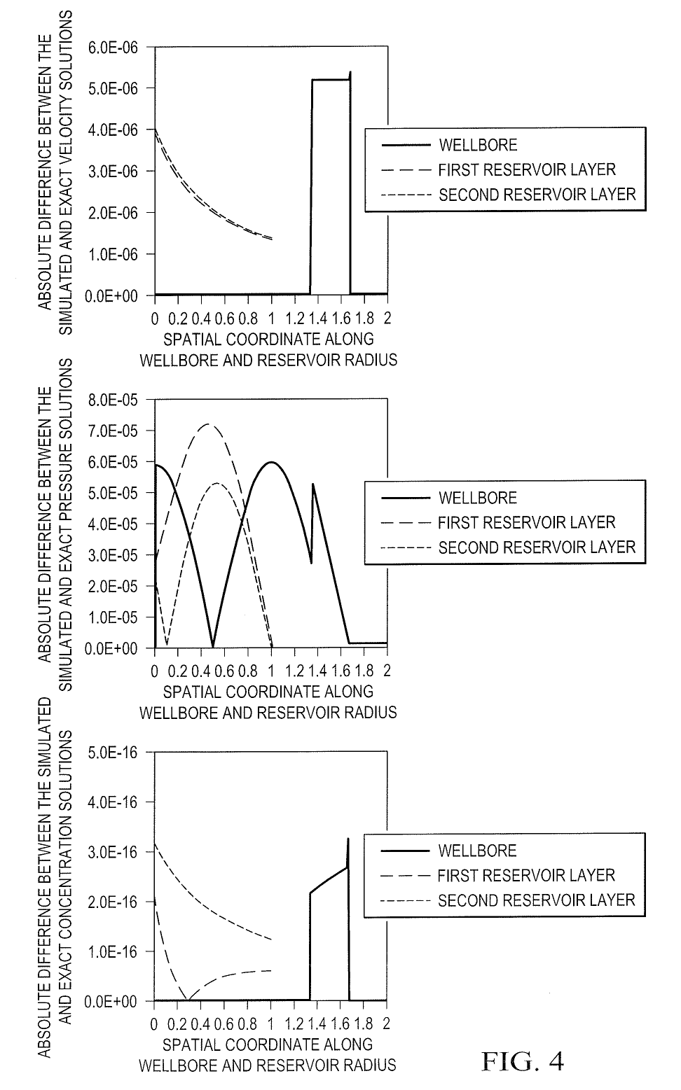

The following test functions were used: u=xt, p=t cos(πx), and c=xt in the wellbore and u=rt, p=t cos(πr), and c=rt in the reservoir with μ₁=1.2×10⁻³(pa·s), ρ₁=1.2×10³(kg/m³), and μ₂=1.0×10⁻³(pa·s), ρ₂=1.0×10³(kg/m³), as well as λ=1, Dₑ=D₀=10⁻⁶(m²/s). The computation domain was defined by the wellbore length, the wellbore diameter by D_{w}=0.1(m), the reservoir radius by rₑ=1.0(m), and the height by H1.0(m). The Reynolds number was 100, the porous media permeability K=1.0×10⁻⁶ m², and the porosity 0.2. The two connection points were located at x=1.4 and x=1.7. The grid spacing was 0.01 for both the wellbore and reservoir, and the time step was 0.01 seconds. FIG. 4 depicts the comparisons. The code captures the pressure oscillatory behavior very well, and with the error for velocity and concentration is bounded within 1.0e-5, which is consistent with the second-order spatial accuracy. The maximum absolute pressure error of 1.0e-4 is consistent with the first-order accuracy in time. The larger error compared to Test Case 1 is a result of nonlinearity and the oscillatory nature of the test functions and occurs at the junctions, where velocity and concentration are actually approximated in the first-order manner.

FIG. 4 illustrates a comparison of MMS for test functions ofu=xt, p=t cos(ρx), and c=xt in the wellbore and u=rt, p=t cos(ρr), and c=rt in the reservoir at time t=1.49.

### Example 3

### Compressibility Effects

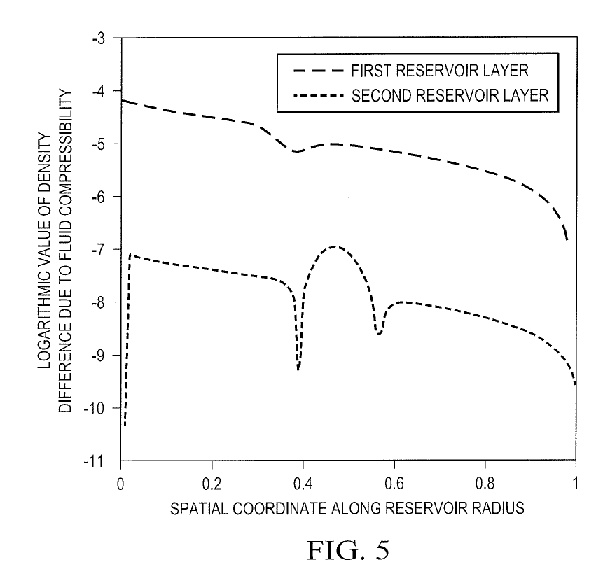

To examine the compressibility effect on the fluid mixture in reservoir, the computation domain the same as in Example 2 was set up, namely and oscillatory test function. The two fluids, fluid 1 and fluid 2 were assumed to have the same constant compressibility in the reservoir with the value as a₁=a₂=7.3×10⁻¹⁰(Pa⁻¹). FIG.5 shows the logarithmic value of fluid density difference between the fluid with compressibility and incompressible fluid in the reservoir. This test case shows the numerical procedure is well capable of taking into account fluid compressibility in the reservoir.

A case study of an open-hole drilling system consisting of a vertical wellbore and a horizontal reservoir is also helpful in understanding the present disclosure. The wellbore was assumed to have a diameter of D=0.1m and a length of L_{w}=1000.0 m. The reservoir formation had a height of pay zone of 500.0 m, an effective outer radius ofrₑ=100.0 m, with the porous permeability of K=1.0×10⁻⁶ m² and porosity of 0.2. And the reservoir formation was assumed to have ten uniform layers. The system was assumed to be initially filled with fluid 2, which is the case when the reservoir is filled just with water, e.g., with μ₂=1.0×10⁻(pa·s), ρ₂=1.0×10⁻³(kg/m³). Fluid 1 with μ₁=1.2×10⁻³(pa·s), ρ₁=1.2×10³(kg/m³) was assumed to be injected with a velocity uᵢₙₗₑₜ=5.0 m/s. Two fluids are assumed to be incompressible in the reservoir. And the retarding convective factor λ and the effective diffusion coefficient Dₑ take forms as given by:

$$λ = 1 - ( {λ}_{d} + {λ}_{μ} \frac{{μ}_{2} - {μ}_{1}}{{μ}_{2} + {μ}_{1}} + {λ}_{ρ} \frac{{ρ}_{1} - {ρ}_{2}}{{ρ}_{2} + {ρ}_{1}} ) \sqrt{\frac{{f}_{f}}{2}}$$

$${D}_{e} = {D}_{m} + ( {D}_{d} + {D}_{μ} \frac{{μ}_{2} - {μ}_{1}}{{μ}_{2} + {μ}_{1}} + {D}_{ρ} \frac{{ρ}_{1} - {ρ}_{2}}{{ρ}_{2} + {ρ}_{1}} ) UD$$

$$with , \\ {λ}_{d} = 0.184 + 1.284 tanh ( 0.0038 Pe )$$

$${λ}_{μ} = \sqrt{0.32 ( 1 - \frac{{μ}_{2}}{{μ}_{2} + {μ}_{1}} )}$$

$${λ}_{ρ} = \sqrt{\frac{1}{20} ( 1 - \frac{{ρ}_{1}}{{ρ}_{2} + {ρ}_{1}} )}$$

$${D}_{m} ≡ 1.0 \times {10}^{- 6} ( {m}^{2} \text{/} s )$$

$${D}_{d} ≡ \frac{Pe}{8 \times 192}$$

$${D}_{μ} ≡ \frac{Sc}{8 \times 192} ( 1 - \frac{{μ}_{2}}{{μ}_{2} + {μ}_{1}} )$$

$${D}_{ρ} ≡ \frac{Re}{32 \times 192} ( 1 - \frac{{ρ}_{1}}{{ρ}_{2} + {ρ}_{1}} )$$

Here, Re is the Reynolds number, Pe is the Peclet number, and Sc is the Schmidt number, which are defined as follows:

$$Re = \frac{{ρ}_{1} + {ρ}_{2}}{{μ}_{1} + {μ}_{2}} UD ; Pe = \frac{UW}{{D}_{m}} ; Sc = \frac{{μ}_{1} + {μ}_{2}}{( {ρ}_{1} + {ρ}_{2} ) {D}_{m}} .$$

And the friction factor

$${f}_{f} = \{ \begin{matrix}\frac{64}{Re} & Re \leq 2300 \\ 0.079 {Re}^{- 0.25} & Re > 2300\end{matrix} , \\ U = {u}_{inlet} , and {α}_{L} = 5.0 m \text{/} s$$

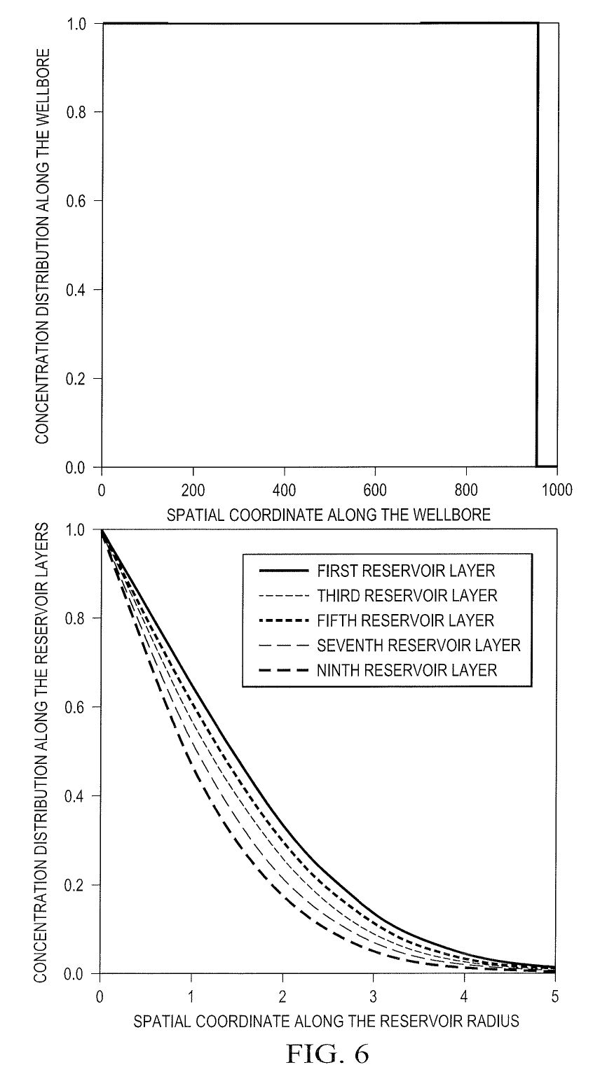

with a grid size of 1.0 m for both the wellbore and reservoir and a time step of 0.1 seconds. Simulation results are shown in FIGS. 6 through 10.

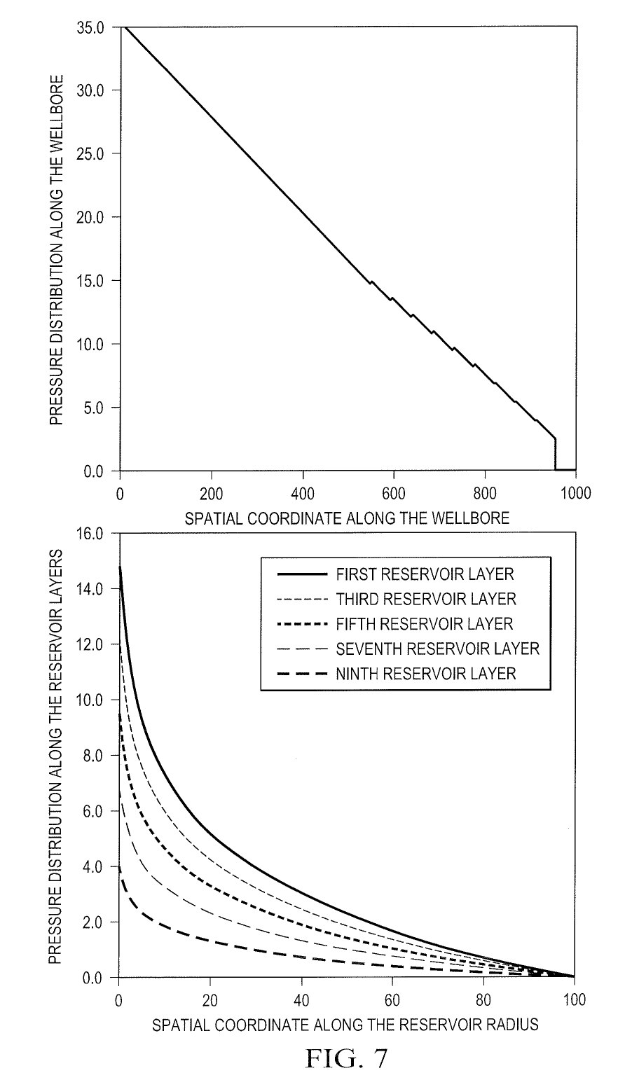

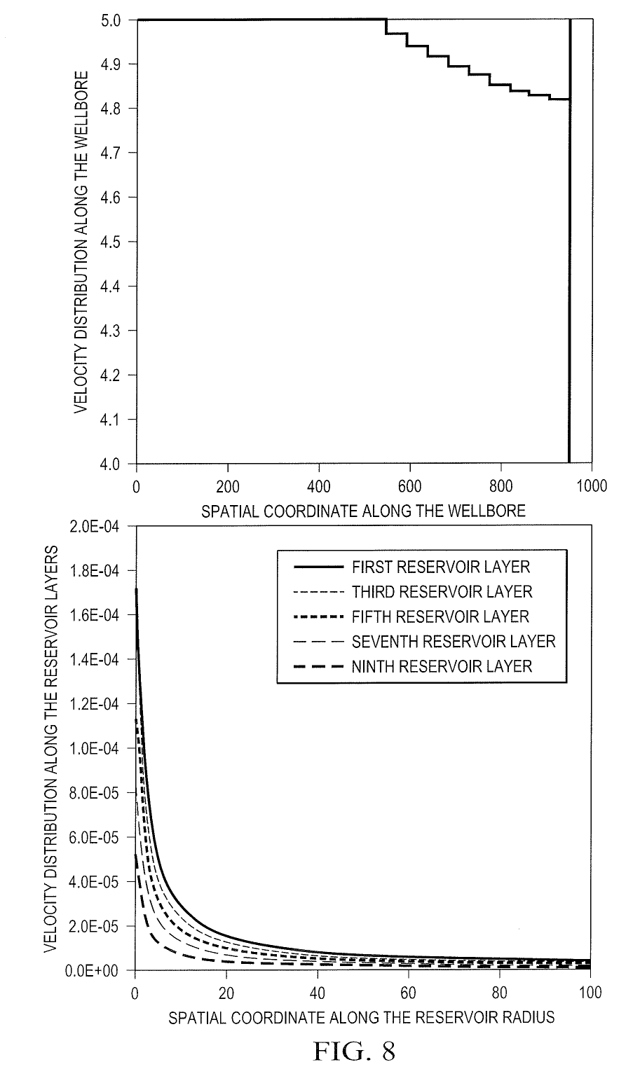

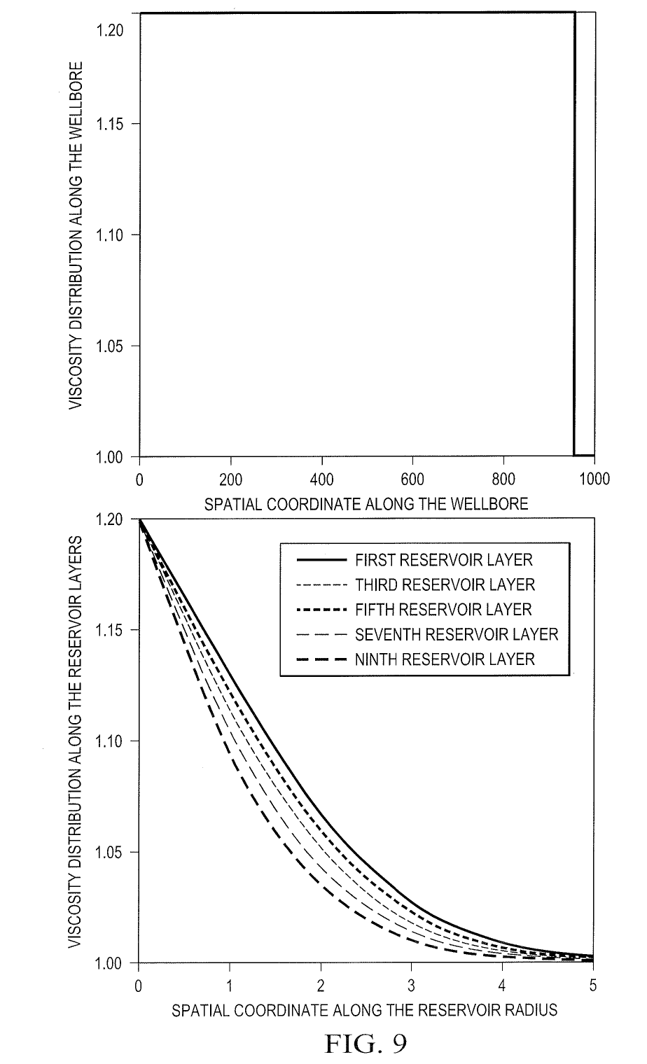

The concentration profiles in FIG. 6 show the fluid fronts and the fluid mixing zone sizes along the wellbore and the reservoir layers. In the wellbore, the concentration is 1.0, which indicates that it is filled with Fluid 1. In the reservoir, the concentration varies between 1 to 0, indicating mixing and diffusion in the reservoir. The pressure in FIG. 7 decreases but jumps at the wellbore-reservoir interface along the wellbore because of flow loss. The discontinuity of the pressure along the wellbore results from the velocity discontinuity, as shown in FIG. 8. In the case of inviscid flow, the Bernoulli equation shows that flow loss results in pressure spikes. Moreover, the velocity at the last connection in the wellbore spikes locally because it is modeled by Darcy's law, and pressure is continuous at this last connection point. In addition, the pressure and velocity distributions along the reservoir are radial because of inherent radial flow assumptions. Viscosity profiles in FIG. 9 show the linear relationship between viscosity and the concentration; therefore, FIGS. 9 and 6 are qualitatively similar. Density profiles, which are not plotted, have profiles similar to the concentrations profiles because the linear relationship between density and concentration is used in the model.

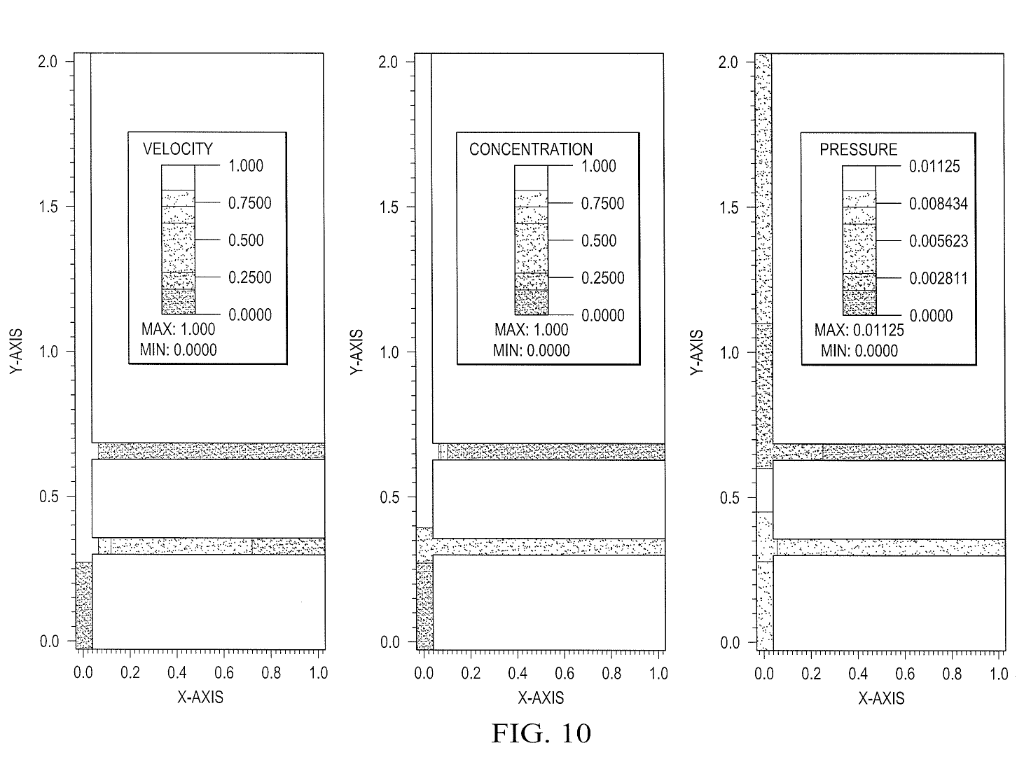

FIG. 10 shows that contour plots of velocity, pressure, and concentration for two reservoir layers during injection at a Reynolds number of 10,000. The solution time step is 0.01 seconds, and the simulation time is 2.49 seconds. Most of the fluid flows through the second layer, as shown in FIG. 9a, because the permeability of the first layer is smaller compared to the second layer. The solution is stable at these high Reynolds numbers typically found in wellbore flow. These results indicate that the numerical scheme developed for this model is robust and results in very stable solutions for long-period simulations.

The present disclosure presents a new physics and numerical methodology, discretization, and model to simulate the miscible fluid displacement process in any completion system. The methodology includes coupling mechanisms for scalar, velocity, and pressure dynamics at the junction points, numerical simulation approaches to solve different systems of partial differential equations in each domain, and geometrical modeling of open-hole completion systems. This study simulated the miscible fluid displacement process in an open-hole completion system. The solution obtained from numerical simulations is fast, robust, feasible, efficient, and easy to use. Prediction of miscible fluid displacement dynamics in a complex wellbore-reservoir network is a challenge but can be executed robustly with the new methodology developed here.

The model and numerical algorithm are applicable to multistage and multi-fluid transport in hybrid wellbore-reservoir systems for any well completion, such as perforation or slotted liner. Therefore, it is expected that the model can have a significant impact in the simulation of well production enhancement processes through the proposed coupling mechanisms of velocity, pressure, and marker concentration across the wellbore-reservoir interface for typical Reynolds numbers observed in the field.

Although the present disclosure and its advantages have been described in detail, it should be understood that various changes, substitutions and alterations can be made herein without departing from the spirit and scope of the disclosure as defined by the following claims.

What is claimed is:

1. A computer-implemented method for higher-order simulation, design and implementation of a strategy for injecting a plurality of stimulation fluids into a subterranean formation, the method comprising:
(a) receiving a plurality of inputs, including the flow rate, viscosity and density of each of the plurality of stimulation fluids being injected into the subterranean formation, the dimensions of a wellbore into which the plurality of stimulation fluids are injected, the properties of a reservoir containing hydrocarbons intersected by the wellbore, and at least one marker identifier at an interface of at least two distinct stimulation fluids;
(b) determining a pressure variation and distribution for each of the plurality of stimulation fluids over a plurality of discrete points along the wellbore and reservoir wherein the pressures in the distribution are determined using a second-order accurate approximation discretization;
(c) determining a marker pattern at the plurality of discrete points along the wellbore and reservoir, wherein each marker identifier in the pattern is determined using a second-order accurate approximation;
(d) analyzing the pressure distribution and marker pattern to determine whether the stimulation fluids are achieving desired downhole conditions; and
(e) adjusting the flow rate of one or more of the plurality of stimulation fluids at an injection point at the wellbore when the desired downhole conditions are not being met.

2. The computer-implemented method of claim 1, wherein the wellbore dimensions include diameter, length and deviation angle.

3. The computer-implemented method of claim 1, wherein the reservoir properties include the number of layers, layer height, layer porosity and layer permeability.

4. The computer-implemented method of claim 1, wherein the pressure and velocity distributions along the wellbore are determined using the following equations:
$$\begin{matrix}\frac{\partial ρ}{\partial t} + \frac{\partial }{\partial x} ( ρ u ) = 0 & ( 1 ) \\ \frac{\partial ( ρ u )}{\partial t} + \frac{\partial ( ρ {u}^{2} )}{\partial x} + \frac{\partial p}{\partial x} + {f}_{f} \frac{ρ {u}^{2}}{π D} = \frac{\partial }{\partial x} ( μ \frac{\partial u}{\partial x} ) + ρ g cos θ & ( 2 )\end{matrix}$$
where equation (1) is the fluid mass continuity equation and equation (2) is the momentum conservation equation, θ is the wellbore deviation with respect to vertical, and where the density ρ and viscosity μ are modeled by means of linear functions of concentration c as follows:
ρ=(ρ₁−ρ₂)c+ρ₂
μ=(μ₁−μ₂)c+μ₂
The friction force f_{f} in the momentum Eq. 2 is modeled as
$${f}_{f} = \{ \begin{matrix}\frac{64}{Re} & Re \leq 2300 \\ 0.079 {Re}^{- 0.25} & Re > 2300\end{matrix}$$
where the Reynolds number is defined as
$$Re = \frac{ρ UD}{μ} .$$
U is chosen as the injected fluid average velocity at the wellhead, and D is the wellbore diameter.

5. The computer-implemented method of claim 1, wherein the pressure and velocity distributions along the reservoir are determined using the following equations:
$$\frac{\partial ( φ ρ )}{\partial t} + \frac{\partial ( r ρ u )}{\partial r} = 0$$
$$u = - \frac{K}{μ} \frac{\partial p}{\partial r}$$
where ρ is the fluid density and μ the viscosity. φ and K are the reservoir porosity and permeability, respectively.

6. The computer-implemented method of claim 1, wherein the marker pattern at the plurality of discrete points along the wellbore is determined using the modified convection-diffusion equation:
$$\frac{\partial c}{\partial t} + \frac{\partial }{\partial x} ( λ uc ) = \frac{\partial }{\partial x} ( {D}_{e} \frac{\partial c}{\partial x} )$$
wherein the retarding convective factor λ and effective diffusive coefficient Dₑ are modeled as the following:
$$λ = 1 - ( {λ}_{d} + {λ}_{μ} \frac{{μ}_{2} - {μ}_{1}}{{μ}_{2} + {μ}_{1}} + {λ}_{ρ} \frac{{ρ}_{1} - {ρ}_{2}}{{ρ}_{2} + {ρ}_{1}} ) \sqrt{\frac{{f}_{f}}{2}}$$
$${D}_{e} = {D}_{m} + ( {D}_{d} + {D}_{μ} \frac{{μ}_{2} - {μ}_{1}}{{μ}_{2} + {μ}_{1}} + {D}_{ρ} \frac{{ρ}_{1} - {ρ}_{2}}{{ρ}_{2} + {ρ}_{1}} ) UD$$
wherein λ_{d} is the contribution of the fluid dispersion to the retarding convective factor, λ_{μ} is the contribution of the fluids viscosity difference to the retarding convective factor, λ_{ρ} accounts for the contribution of the fluids density difference to the retarding convective factor; and Dₘ is the molecular diffusion, D _{d} is the dispersion, D _{μ} is the contribution of the fluids viscosity difference to effective diffusive coefficient Dₑ, and D_{ρ} is contribution of the fluids density difference to effective diffusive coefficient Dₑ.

7. The computer-implemented method of claim 1, wherein the marker pattern at the plurality of discrete points along the reservoir is determined using the modified convection-diffusion equation:
$$\frac{\partial ( φ c )}{\partial t} + \frac{1}{r} \frac{\partial }{\partial r} ( r λ uc ) = \frac{1}{r} \frac{\partial }{\partial r} ( r ( {D}_{e} + {D}_{dp} ) φ \frac{\partial c}{\partial r} )$$
wherein λ is the retarding convective factor, Dₑ is the effective diffusive coefficient, D _{dp} is the kinematic dispersion and it is modeled as a general polynomial in |u|, where it is enough to use the simplest model given as D_{dp}=a_{L}|u|, where a_{L} is the longitudinal dispersivity.

8. A computer-implemented method for higher-order accurate simulation and enhancement of the flow of production fluids from a subterranean formation, the method comprising:
(a) receiving a plurality of inputs, including the flow rate, viscosity and density of the production fluids, the dimensions of a wellbore into which the production fluids flow to the surface, properties of a reservoir containing the production fluids intersected by the wellbore, and at least one marker identifier at an interface of at least two distinct production fluids;
(b) determining a pressure variation and distribution for each production fluid over a plurality of discrete points along the wellbore and reservoir, wherein the pressures in the distribution are determined using a second-order accurate approximation;
(c) determining a marker pattern at the plurality of discrete points along the wellbore and reservoir, wherein each marker identifier in the pattern is determined using a second-order accurate discretization;
(d) analyzing the pressure distribution and marker pattern to determine whether the production fluids are flowing at a desired rate; and
(e) adjusting the flow rate of the production fluids when the desired flow rate of the production fluids is not being achieved.

9. The computer-implemented method of claim 8, wherein the wellbore dimensions include diameter, length and deviation angle.

10. The computer-implemented method of claim 8, wherein the reservoir properties include the number of layers, layer height, layer porosity and layer permeability.

11. The computer-implemented method of claim 8, wherein the pressure and velocity distribution along the wellbore are determined using the following equations:
$$\begin{matrix}\frac{\partial ρ}{\partial t} + \frac{\partial }{\partial x} ( ρ u ) = 0 & ( 1 ) \\ \frac{\partial ( ρ u )}{\partial t} + \frac{\partial ( ρ {u}^{2} )}{\partial x} + \frac{\partial p}{\partial x} + {f}_{f} \frac{ρ {u}^{2}}{π D} = \frac{\partial }{\partial x} ( μ \frac{\partial u}{\partial x} ) + ρ g cos θ & ( 2 )\end{matrix}$$
where equation (1) is the fluid mass continuity equation and equation (2) is the momentum conservation equation, θ is the wellbore deviation with respect to vertical, and where the density μ and viscosity ρ are modeled by means of linear functions of concentration c as follows:
ρ=(ρ₁−ρ₂)c+ρ₂
μ=(μ₁−μ₂)c+μ²
The friction force f_{f} in the momentum Eq. 2 is modeled as
$${f}_{f} = \{ \begin{matrix}\frac{64}{Re} & Re \leq 2300 \\ 0.079 {Re}^{- 0.25} & Re > 2300\end{matrix}$$
where the Reynolds number is defined as
$$Re = \frac{ρ UD}{μ} .$$
U is chosen as the injected fluid average velocity at the wellhead, and D is the wellbore diameter.

12. The computer-implemented method of claim 8, wherein the pressure and velocity distribution along the reservoir are determined using the following equations:
$$\frac{\partial ( φ ρ )}{\partial t} + \frac{\partial ( r ρ u )}{\partial r} = 0$$
$$u = - \frac{K}{μ} \frac{\partial p}{\partial r}$$
where ρ is the fluid density and μ the viscosity. φ and K are the reservoir porosity and permeability, respectively.

13. The computer-implemented method of claim 8, wherein the marker pattern at the plurality of discrete points along the wellbore is determined using the modified convection-diffusion equation:
$$\frac{\partial c}{\partial t} + \frac{\partial }{\partial x} ( λ uc ) = \frac{\partial }{\partial x} ( {D}_{e} \frac{\partial c}{\partial x} )$$
wherein the retarding convective factor λ and effective diffusive coefficient Dₑ are modeled as the following:
$$λ = 1 - ( {λ}_{d} + {λ}_{μ} \frac{{μ}_{2} - {μ}_{1}}{{μ}_{2} + {μ}_{1}} + {λ}_{ρ} \frac{{ρ}_{1} - {ρ}_{2}}{{ρ}_{2} + {ρ}_{1}} ) \sqrt{\frac{{f}_{f}}{2}}$$
$${D}_{e} = {D}_{m} + ( {D}_{d} + {D}_{μ} \frac{{μ}_{2} - {μ}_{1}}{{μ}_{2} + {μ}_{1}} + {D}_{ρ} \frac{{ρ}_{1} - {ρ}_{2}}{{ρ}_{2} + {ρ}_{1}} ) UD$$
wherein λ_{d} is the contribution of the fluid dispersion to the retarding convective factor, λ_{μ} is the contribution of the fluids viscosity difference to the retarding convective factor, λ_{μ} accounts for the contribution of the fluids density difference to the retarding convective factor; and Dₘ is the molecular diffusion, D_{d} is the dispersion, D₈₂ is the contribution of the fluids viscosity difference to effective diffusive coefficient Dₑ, and D₉₀ is contribution of the fluids density difference to effective diffusive coefficient Dₑ.

14. The computer-implemented method of claim 8, wherein the marker pattern at the plurality of discrete points along the reservoir is determined using the modified convection-diffusion equation:
$$\frac{\partial ( φ c )}{\partial t} + \frac{1}{r} \frac{\partial }{\partial r} ( r λ uc ) = \frac{1}{r} \frac{\partial }{\partial r} ( r ( {D}_{e} + {D}_{dp} ) φ \frac{\partial c}{\partial r} )$$
wherein λ is the retarding convective factor, Dₑ is the effective diffusive coefficient, D_{dp} is the kinematic dispersion and it is modeled as a general polynomial in |u|, where it is enough to use the simplest model given as D_{dp}=a_{L}|u|, where a_{L} is the longitudinal dispersivity.

15. A computer-implemented method for higher-order simulation of the behavior of a plurality of fluids at an intersection of at least two geometrically discrete regions, the method comprising:
(a) receiving a plurality of inputs, including the flow rate, viscosity and density of each of the plurality of fluids, the dimensions of the at least two geometrically discrete regions, and the location of the intersection of the at least two geometrically discrete regions;
(b) determining a pressure of each fluid at the intersection of the at least two geometrically discrete regions, wherein the pressure of each fluid is determined using a second-order accurate approximation; and
(c) determining a marker identifier of each fluid at the intersection of the at least two geometrically discrete regions, wherein the marker identifier of each fluid is determined using a second-order accurate discretization.

16. The computer-implemented method of claim 15, wherein the intersection of the at least two geometrically discrete regions is the intersection of a wellbore in a subterranean formation and a reservoir containing hydrocarbons in that subterranean formation.

17. The computer-implemented method of claim 15, wherein the plurality of fluids is selected from the group consisting of well stimulation fluids and hydrocarbon-based production fluids.

18. The computer-implemented method of claim 15, wherein the equations that govern mass conservation, marker conservation, pressure continuity, density continuity, viscosity continuity, and Darcy's law to model the velocity uᵣ at the intersection of the at least two geometrically discrete regions except the deepest reservoir layer are as follows:
$${ρ}_{w , in} {u}_{w , in} - {ρ}_{w , out} {u}_{w , out} = \frac{2 h}{{R}_{w}} {ρ}_{r} {u}_{r}$$
$${c}_{w , in} {u}_{w , in} - {c}_{w , out} {u}_{w , out} = \frac{2 h}{{R}_{w}} {c}_{r} {u}_{r}$$
$${p}_{w} = {p}_{r}$$
$${μ}_{w} = {μ}_{r}$$
$${ρ}_{w} = {ρ}_{r}$$
$${u}_{r} = - \frac{K}{{μ}_{r}} \frac{\partial {p}_{r}}{\partial r} .$$
where h is the reservoir layer height, R_{w} is the wellbore radius. And any variable with subscripts r, and w represent the variable at reservoir and wellbore, respectively. And any variable (i.e. the velocity and concentration of the marker) with subscripts in, and out represent the variable flows into and flows out of the intersection, respectively.

19. The computer-implemented method of claim 15, wherein the equations that govern mass conservation, marker conservation, pressure continuity, density continuity, viscosity continuity, and Darcy's law to model the velocity uᵣ at the intersection of the at least two geometrically discrete regions at the deepest reservoir layer are as follows:
$${u}_{w} = \frac{2 h}{{R}_{w}} {u}_{r}$$
$${c}_{w} = {c}_{r}$$
$${μ}_{w} = {μ}_{r}$$
$${ρ}_{w} = {ρ}_{r}$$
$$\frac{\partial {p}_{r}}{\partial r} = - \frac{{μ}_{r}}{{ρ}_{r}} {u}_{r} .$$
where h is the reservoir layer height, R_{w} is the wellbore radius, and any variable with subscripts r, and w represent the variable at reservoir and wellbore, respectively.

20. The computer-implemented method of claim 15, wherein the marker identifier is determined according to the follow equation:
$$\frac{{C}_{i}^{n + 1} - {C}_{i}^{n}}{Δ t} + \frac{{( uC )}_{i} - {( uC )}_{i - 1}}{Δ x} + \frac{1}{2.} Δ x ( {f}_{ix} + D {C}_{xxxi} - {C}_{xit} ) - D \frac{{C}_{i - 1} - 2 {C}_{i} + {C}_{i + 1}}{Δ {x}^{2}} = {f}_{i}$$
$$where$$
$${C}_{xxxi} = \frac{1}{Δ {x}^{3}} \{ ( {C}_{i + 2} - 3 {C}_{i + 1} + 3 {C}_{i} - {C}_{i - 1} ) - \frac{5 Δ x}{8} {C}_{xxxxi} \\ or \\ {C}_{xxxi} = \frac{1}{Δ {x}^{3}} \{ ( {C}_{i + 1} - 3 {C}_{i} + 3 {C}_{i - 1} - {C}_{i - 2} ) + \frac{5 Δ x}{8} {C}_{xxxxi} \\ and \\ {C}_{ixt} = \frac{1}{Δ x} \{ \frac{{C}_{i}^{n + 1} - {C}_{i}^{n}}{Δ t} - \frac{{C}_{i - 1}^{n + 1} - {C}_{i - 1}^{n}}{Δ t} \} .$$
